(19) United States
(12) Patent Application Publication
(10) Pub. No.: US 2026/0244252 A1
(43) Pub. Date: Aug. 20, 2026

(54) DYNAMIC POWER RAIL SELECTION FOR SYSTEM-ON-CHIP (SOC)

(71) Applicant: QUALCOMM INCORPORATED, San Diego, CA (US)

(72) Inventors: Prashanth Kumar KAKKIRENI, Bengaluru (IN); Naveen Kumar NARALA, Bengaluru (IN); Sriharsha CHAKKA, Bangalore (IN); Sathish Kumar MASILAMANI, San Diego, CA (US); Chris ROSOLOWSKI, Encinitas, CA (US); Venkatesh Murthy MUTHIGI, Bengaluru (IN)

(21) Appl. No.: 19/056,614

(22) Filed: Feb. 18, 2025

(51) Int. Cl. G06F 1/26

(52) U.S. Cl. CPC G06F 1/26

(57) ABSTRACT

Power rails may be selected at system-on-chip (SoC) boot time using a handshake protocol between the SoC and a power management system, such as a power management integrated circuit (PMIC). Upon a power-up trigger, the SoC may send boot rail information to the PMIC. The boot rail information may indicate one or more power rails configured to supply power to one or more SoC processing components. The PMIC may power up the one or more power rails indicated by the boot rail information and send an acknowledgement to the SoC. The one or more processing components may be booted in response to the acknowledgement.

### DESCRIPTION OF THE RELATED ART

A computing device may include multiple subsystems, cores, or other components. Such a computing device may be, for example, a portable computing device, such as a cellular telephone or smartphone, a desktop, laptop, palmtop or tablet computer, a so-called Internet-of-Things device, a wearable device, an automotive computing device, etc. The multiple subsystems, cores, or other components of a computing device may be included within different chips or in the same integrated circuit chip. A “system-on-chip” or “SoC” is an example of a chip that integrates numerous components to provide system-level functionality.

For example, a SoC may include one or more types of processors, such as central processing units (CPUs), graphics processing units (GPUs), digital signal processors (DSPs), neural processing units (NPUs), etc. A SoC for a wireless computing device may also include one or more radio transceivers. A SoC may have a monolithic architecture in which the components are included in a single die, or a chiplet architecture in which the components are distributed among two or more co-packaged dies.

Power may be supplied to a SoC by another chip, which may be referred to as a power management integrated circuit (PMIC). The PMIC may have regulators to drive multiple power domains and the circuit to control the regulator operation. PMIC regulators may be used to supply multiple subsystems, cores, or other components in the SOC.

When the system is booted, the PMIC may power up the multiple power rails. So long as all of the SoC components supplied by these power rails are to be utilized in operation of the computing device, powering up the SoC in this manner may have no undesirable effects. Nevertheless, there may be instances in which some SoC components are not to be utilized in operation of the computing device.

### SUMMARY OF THE DISCLOSURE

Systems, methods, and other examples of dynamic power rail selection are disclosed.

An exemplary method for dynamic power rail selection may include sending boot rail information to a power management system. The boot rail information may indicate one or more power rails of a plurality of power rails. The method may further include, in response to receiving the boot rail information, powering up the one or more power rails indicated by the boot rail information. The method may still further include booting, in response to the powering-up of the one or more power rails, one or more processing components supplied by the one or more power rails.

An exemplary system for dynamic power rail selection may include boot rail information control circuitry and boot control circuitry. The boot rail information control circuitry may be configured to send boot rail information to a power management system. The boot rail information may indicate one or more power rails of a plurality of power rails. The power management system may be configured to power up the one or more power rails indicated by the boot rail information. The boot control circuitry may be configured to boot, in response to power-up of the one or more power rails, one or more processing components supplied by the one or more power rails.

An exemplary processing system may include a plurality of processing components, boot rail information control circuitry, and boot control circuitry. The processing system may comprise a system-on-chip (SoC), which may have a monolithic SoC architecture or a chiplet SoC architecture. The boot rail information control circuitry may be configured to send boot rail information to a power management integrated circuit (PMIC) via a data communication bus. The boot rail information may indicate one or more power rails of a plurality of power rails. The PMIC may be configured to power up the one or more power rails indicated by the boot rail information. The boot control circuitry associated with the plurality of processing components may be configured to boot the one or more processing components supplied by the one or more power rails in response to the power-up of those power rails.

### BRIEF DESCRIPTION OF THE DRAWINGS

In the Figures, like reference numerals refer to like parts throughout the various views unless otherwise indicated. For reference numerals with letter character designations such as “101A” or “101B”, the letter character designations may differentiate two like parts or elements present in the same Figure. Letter character designations for reference numerals may be omitted when it is intended that a reference numeral encompass all parts having the same reference numeral in all Figures.

FIG. 1 is a functional block diagram of a system for dynamic power rail selection in a computing device, in accordance with exemplary embodiments.

FIG. 2 is a functional block diagram of another system for dynamic power rail selection in a computing device, in accordance with exemplary embodiments.

FIG. 3 is a signaling sequence diagram illustrating dynamic power rail selection, in accordance with exemplary embodiments.

FIG. 4 is a block diagram of a chiplet implementation of a system for dynamic power rail selection in a computing device, in accordance with exemplary embodiments.

FIG. 5 is similar to FIG. 4, illustrating another chiplet implementation, in accordance with exemplary embodiments.

FIG. 6 is similar to FIGS. 4-5, illustrating still another chiplet implementation, in accordance with exemplary embodiments.

FIG. 7 is a flow diagram illustrating a method for dynamic power rail selection in a computing device, in accordance with exemplary embodiments.

FIG. 8 is a block diagram of a portable computing device having a dynamic power rail selection feature, in accordance with exemplary embodiments.

### DETAILED DESCRIPTION

The word “exemplary” is used herein to mean “serving as an example, instance, or illustration.” The word “illustrative” may be used herein synonymously with “exemplary.” Any aspect described herein as “exemplary” is not necessarily to be construed as preferred or advantageous over other aspects.

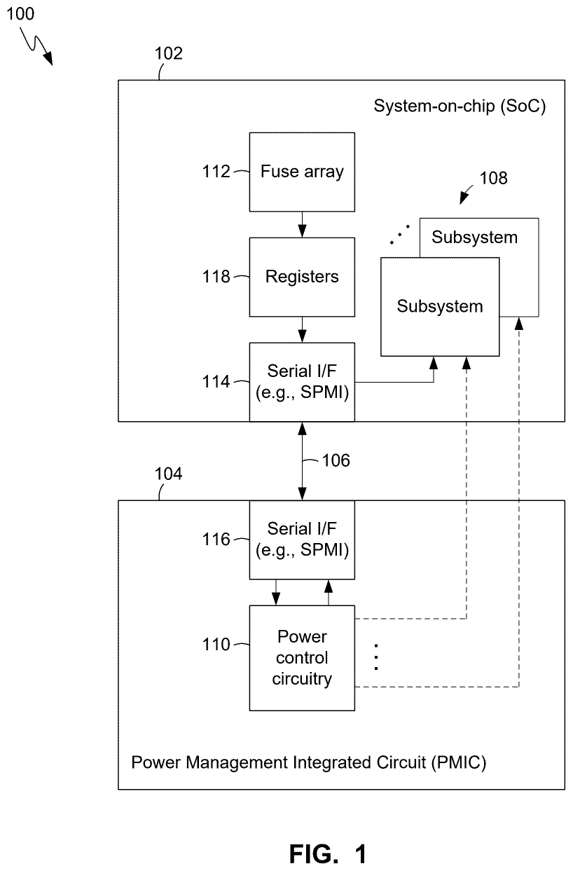

As shown in FIG. 1, in an illustrative or exemplary embodiment a system 100 may include a system-on-chip (SoC) 102 and a power management integrated circuit (PMIC) 104. Although not shown in FIG. 1 for purposes of clarity, the system 100 may be included in a computing device, such as, for example, a cellular telephone or smartphone, a desktop, laptop, palmtop or tablet computer, a so-called Internet-of-Things device, a wearable device, an automotive computing device, etc. A data communication bus 106 may couple the SoC 102 and PMIC 104. The data communication bus 106 may be, for example, a System Power Management Interface (SPMI) bus, which is a high-speed bidirectional serial bus for real-time control of supply voltage and clock frequency scaling in multi-core processing systems, promulgated by the Mobile Industry Processor Interface Alliance (MIPI). In other examples, such as data communication bus could be an Inter-Integrated Circuit (I2C) bus, or any other data communication interface.

The SoC 102 may include any number of subsystems 108, such as processing systems (which may also be referred to as processing components). Examples of such subsystems 108 may include central processing unit (CPU) subsystems, neural processing unit (NPU) subsystems, graphic processing unit (GPU) subsystems, etc., or cores thereof. Although not shown for purposes of clarity, the SoC 102 may also include other subsystems, such as memory subsystems, wireless connectivity subsystems, etc.

The term “system-on-chip” or “SoC,” as used herein, includes chiplet architectures as well as monolithic (i.e., single-die) architectures. In a chiplet architecture, the subsystems may be distributed among two or more closely integrated chips or dies (i.e., chiplets), within the same chip-scale package, and which may be coupled through an integrated high-speed data communication interface. A SoC having a chiplet architecture may be functionally equivalent to a SoC having a monolithic architecture.

The PMIC 104 may include power control circuitry 110 configured to supply power to the subsystems 108 via one or more power rails, i.e., conductive paths (conceptually indicated in broken line in FIG. 1). Generally, when a computing device that includes the system 100 is turned on, re-booted, or otherwise readied for operation, the PMIC 104 may begin supplying power to the subsystems 108. Nevertheless, there may be instances in which one or more of the subsystems 108 are not to be utilized during computing device operation and should remain powered off. It may be desirable, during an initial phase of booting the system 100, to power on only those one or more subsystems 108 that are needed for booting and to leave one or more others of the subsystems 108 powered off. The terms “power on” and “power up” may be used synonymously herein, as may the terms “power off” and “power down.”

The SoC 102 may also include a fuse array 112. The term “fuse array” or “fuses” as used herein refers to an array or other configuration of programmable data cells on a chip in the form of physically one-time configurable features, analogous to a traditional read-only memory (ROM). Fuses may comprise silicon or metal traces, the conductivity of which, using an on-chip electronically controllable process, can be substantially reduced (e.g., to zero or near zero) to reflect a data bit value. Colloquially, the process is said to “blow” a fuse. Blowing a fuse may be essentially a one-time-only or irreversible process. A chip may be configured through fuses prior to the chip being installed in a computing device (e.g., at the time the chip is manufactured, tested, etc.). Fuses may be used to store configuration information that is to remain unchanged or rarely changed during the lifetime of the chip. An “eFuse” or electronic fuse is a type of fuse that can be changed dynamically, e.g., while the computing device is in operation. As used herein, the term “fuse” includes all such programmable fuses.

The fuse array 112 may be configured or programmed with boot rail information representing or indicating one or more of the SoC power rails that supply one or more of the subsystems 108. These one or more SoC power rails may be fewer than all of the SoC power rails. The configuration or programming of the fuse array 112 may, for example, indicate power rails supplying only those subsystems 108 (e.g., cores, clusters, etc.) that passed a test for proper operation and not indicate power rails supplying others of the subsystems 108 that did not pass such a test. Powering up a faulty subsystem 108 at boot time may be undesirable, as it may adversely affect other operation in the computing device. The configuration or programming of the fuse array 112 may, for example, indicate the subset of power rails needed for booting the SoC 102 and omit power rails not needed for booting or that may supply those subsystems 108 that are not to be utilized in operation of the computing device (e.g., faulty cores, clusters, etc.).

During an initial phase of booting the system 100, the boot rail information may be read from the fuse array 112 and sent to the PMIC via the serial data bus 106. The SoC 102 may include a serial interface portion 114 (e.g., a so-called SPMI “master”), while the PMIC 104 may include another serial interface portion 116 (e.g., a so-called SPMI “slave”), which together may be configured to enable serial data communication between the SoC 102 and PMIC 104 via the data communication bus 106. The boot rail information that is read from the fuse array 112 may be stored in register circuitry 118 in the SoC 102. The register circuitry 118 may include control circuitry (not separately shown) configured to read the fuse data, i.e., boot rail information, from the fuse array 112 and store it in registers. The boot rail information may then be sent from the register circuitry 118 by the serial interface portion 114 in the SoC to the serial interface portion 116 in the PMIC 104 via the data communication bus 106. Nevertheless, in other examples (not shown) of such a system, registers may be omitted, and the boot rail information may be transferred directly from such a fuse array to such a serial interface portion. Any protocol may be used to transfer the boot rail information, including directly sending the boot rail information to the PMIC 104, polling the PMIC 104 for the boot rail information, etc.

The power control circuitry 110 in the PMIC 104 may then use the received boot rail information to power up only those one or more SoC power rails indicated by the boot rail information, leaving any other SoC power rails powered off. Accordingly, only those subsystems 108 supplied by the SoC power rails indicated by the boot rail information may be powered up during the SoC boot process, leaving any other subsystems 108 powered off during the SoC boot process.

The boot rail information may indicate the SoC power rails to be powered on at SoC boot time in any manner. In some examples, the boot rail information may include information indicating only the SoC power rails to be powered on at SoC boot time, and any remaining SoC power rails that are not indicated by that information are implicitly not to be powered on at SoC boot time. Conversely, in other examples the boot rail information may include information indicating only the SoC power rails not to be powered on at SoC boot time, and any remaining SoC power rails that are not indicated by that information are implicitly to be powered on at SoC boot time. In still other examples, the boot rail information may include information indicating the SoC power rails to be powered on at SoC boot time as well as information indicating the SoC power rails not to be powered on at SoC boot time.

When the power control circuitry 110 has powered up the SoC power rails identified by the boot rail information, the power control circuitry 110 may send an acknowledgement or “power ready” signal to the SoC 102 via the data communication bus 106. That is, the acknowledgement from the power control circuitry 110 may be sent by the serial interface portion 116 in the PMIC 104 to the serial interface portion 114 in the SoC 102 via the data communication bus 106. In response to receiving the acknowledgement, the one or more subsystems 108 (including portions such as cores, clusters, etc.) that are supplied by the then-powered-on power rails may boot up. This handshake between the SoC 102 and the PMIC 104, in which the SoC 102 indicates which power rails are to be powered up, and in which the PMIC 104 acknowledges that those power rails have been powered up, may ensure that the SoC 102 proceeds with the booting process only after the power rails required for booting have been powered on.

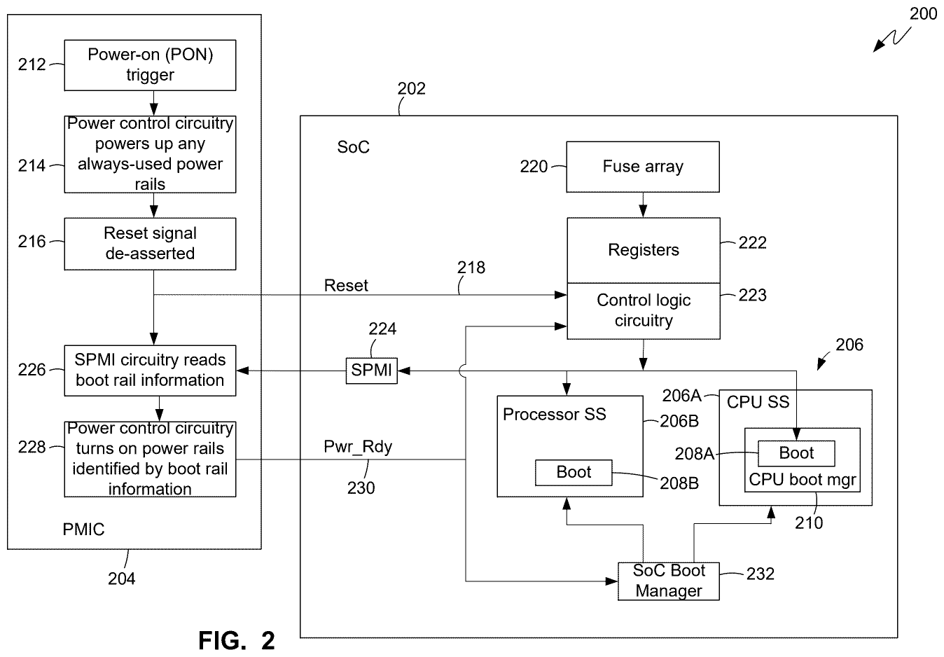

As shown in FIG. 2, another system 200 may include a SoC 202 and a PMIC 204, which may be examples of the SoC 102 and PMIC 104 (FIG. 1), respectively. The SoC 202 may include any number of processor subsystems 206, such as, for example, a CPU subsystem (SS) 206A and another processor subsystem 206B. The CPU subsystem 206A may include boot circuitry 208A. The boot circuitry 208A may be included in CPU boot manager circuitry 210 of the CPU subsystem 206A. The other processor subsystem 206B may similarly include boot circuitry 208B. The boot circuitry 208A and 208B may include, for example, finite state machines configured to control aspects of booting the CPU subsystem 206A and the other processor subsystem 206B, respectively.

Operations in the PMIC 204, which is shown in functional block diagram form, may begin in response to a power-on (PON) trigger 212. The PON trigger 212 may be generated, for example, when a user initially powers on a computing device. In response to the PON trigger 212, a power control circuitry portion 214 may turn on any always-used power rails. Such always-used power rails may supply power to circuitry or components that are initially powered up in all instances of operation, such as general clock circuitry, interfaces, etc., which may be contrasted with the circuitry or subsystems referred to herein that may be selectively powered up based on boot rail information. There may be one or more such always-used power rails.

Following the powering up of any always-used power rails, reset signal circuitry 216 may de-assert a Reset signal 218. The Reset signal 218 may be a master reset signal that, while asserted, maintains circuitry in the SoC 202 in a reset or initialized state in preparation for beginning operation. In the illustrated example, it is this de-assertion of the Reset signal 218 that triggers the reading of the boot rail information from a fuse array 220 in the SoC 202 into register circuitry 222 in the SoC 202. Nevertheless, in other examples (not shown) of such a system, reading of boot rail information from a fuse array may be triggered by other signals or events.

The register circuitry 222 may provide the boot rail information to SPMI circuitry 224 via boot rail information control circuitry 223 associated with the register circuitry 222. The SPMI circuitry 224 may serve as an SPMI master and may send the boot rail information to the PMIC 204. Corresponding SPMI (e.g., slave) circuitry 226 in the PMIC 204 may read or receive the boot rail information.

Another power control circuitry portion 228 in the PMIC 204 may turn on, i.e., power up, power rails that are identified by the received boot rail information. When these power rails have been powered up, the power control circuitry portion 228 may send an acknowledgement or power-ready signal (“Pwr_Rdy”) 230 to the SoC 202.

Some of the processor subsystems 206 may be configured to receive power control signals from SoC Boot Manager circuitry 232, which may also be included in the AOSS 226. The acknowledgement or Pwr_Rdy signal 230 may be provided to the SoC Boot Manager circuitry 232. The boot rail information control circuitry 223 associated with the register circuitry 222 may, among other functions, control the timing (e.g., clock signal control) of the distribution of the boot rail information, and so the acknowledgement or Pwr_Rdy signal 230 may also be provided to the boot rail information control circuitry 223. The boot rail information control circuitry 223 may provide boot trigger signals to the processor subsystems 206 following receipt of the acknowledgement or Pwr_Rdy signal 230. In response to such signals, the boot circuitry 208A, 208B, etc., may boot the respective processor subsystems 206A, 206B, etc.

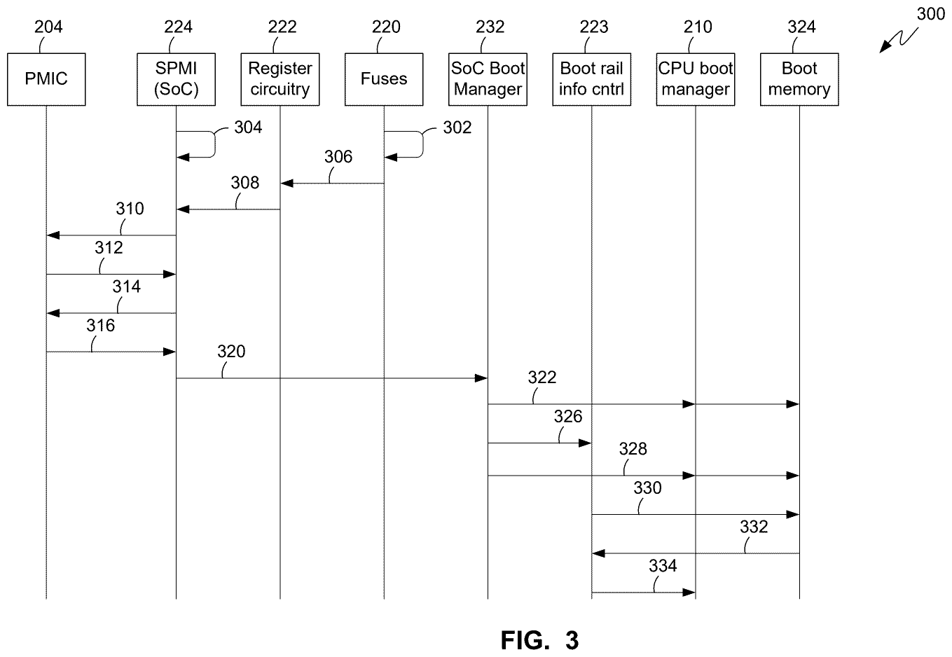

In FIG. 3, a signaling sequence diagram 300 may illustrate further aspects of the booting process described above with regard to FIG. 2. Although not shown in FIG. 3, operation may begin with application of power to the PMIC 204 (FIG. 2), i.e., the above-described PON trigger 212 (FIG. 2). Also not shown are the powering on of any power rails that may always be utilized, i.e., that are not configurably or selectively powerable in accordance with the solutions herein. The operations illustrated in the sequence diagram 300 may begin following de-assertion of the above-described Reset signal 218 (FIG. 2).

Reading 302 of the boot rail information (i.e., fuse data) from the fuses 220 may be performed in response to the de-assertion of the Reset signal 218 (FIG. 2). Also, configuration or initialization 304 of the SPMI circuitry 224 in the SoC 202 (FIG. 2) may be performed in response to the de-assertion of the Reset signal 218. Note in FIG. 3 that, with the exception of the PMIC 204, all of the components involved in the illustrated sequence of operation are located in the SoC 202. Copying 306 the boot rail information from the fuses 220 into the register circuitry 222 may then be performed. The copying 306 may be followed by, or occur concurrently with, sending 308 the boot rail information from the register circuitry 222 to the SPMI circuitry 224.

The SPMI circuitry 224 may send a ready indication 310 to the PMIC 204, indicating that the boot rail information is ready to be provided to the PMIC 204. In response to the ready indication 310, the PMIC 204 may poll 312 the SPMI circuitry 224. In response to the poll 312, a transfer 314 of the boot rail information from the SPMI circuitry 224 to the PMIC 204 may be performed. Alternatively to the SPMI circuitry 224 sending the ready indication 310 and the PMIC 204 polling the SPMI circuitry 224 for the boot rail information, the SPMI circuitry 224 may send the boot rail information to the PMIC 204 without first being polled or otherwise requested. For example, the SPMI circuitry 224 may proactively write the boot rail information to registers (not separately shown) in the PMIC 204.

When the PMIC 204 has completed powering up the power rails identified by the boot rail information, the PMIC 204 may provide an assertion 316 of the above-described acknowledgement or Pwr_Rdy signal. Then, the SPMI circuitry 224 may provide an indication 320 of the initiation via the SoC Boot Manager circuitry 232 of configuring the boot rail resources in response to the assertion 316 of the Pwr_Rdy signal. Such initiation may include a provision 322 by the SoC Boot Manager circuitry 232 of enablement signals to the CPU boot manager circuitry 210 and a boot memory 324. The boot memory 324, which is not shown in the above-described system 200 (FIG. 2) for purposes of clarity, may contain firmware or software that the processor subsystems 206 (FIG. 2) may execute as part of the boot process. The boot memory 324 may be of a type referred to as tightly coupled memory, which may have features enabling the CPU subsystem 206A (FIG. 2) to access the boot memory 324 more readily than a system-wide memory. Reset release signals 326 may be provided to the boot rail information control circuitry 223. A similar reset release signal 328 may be provided to the CPU boot manager circuitry 210 and the boot memory 324.

The boot rail information control circuitry 223 may then send a trigger signal 330 to the boot memory 324. In response to the trigger signal 330, the boot memory 324 may send a trigger acknowledgement signal 332 to the boot rail information control circuitry 223. In response to the trigger acknowledgement signal 332, the boot rail information control circuitry 223 may send a boot trigger signal 334 to the CPU boot manager circuitry 210. Although not shown in FIG. 3 for purposes of clarity, in response to the boot trigger signal 334, the boot circuitry 208A (FIG. 2) of the CPU boot manager circuitry 210 may control booting of the CPU subsystem 206A, which may include, for example, initiating loading or execution of boot software from the boot memory 324, etc.

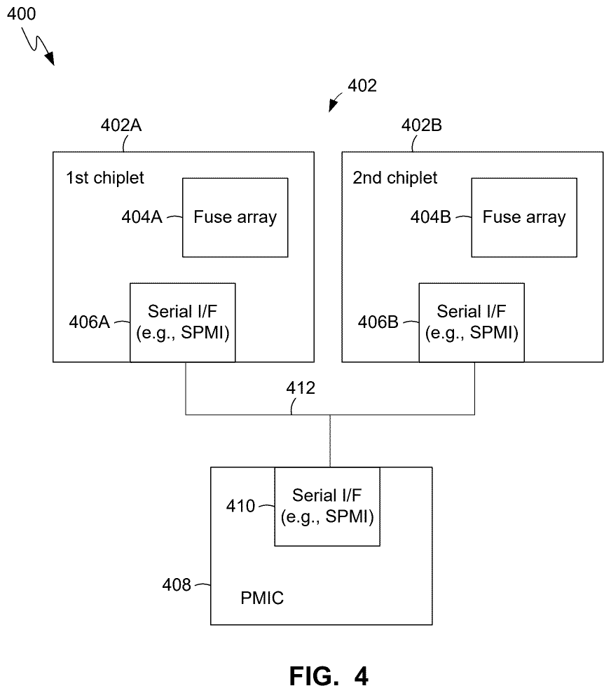

In FIG. 4, a system 400 may include two or more chiplets 402, such as a first chiplet 402A and a second chiplet 402B. The chiplets 402A and 402B may be co-packaged and together operate in the manner of a SoC. For example, each chiplet 402A and 402B may include one or more processor subsystems (not separately shown), analogously to the above-described inclusion of the processor subsystems 108 (FIG. 1) in the SoC 102 or the processor subsystems 206 (FIG. 2) in the SoC 202.

Although the chiplets 402A and 402B may differ in processing functions or other aspects, the chiplets 402A and 402B may include similar dynamic power rail selection features. For example, the chiplets 402A and 402B may include fuse arrays 404A and 404B, respectively, which may contain boot rail information. The (“first”) boot rail information of the fuse array 404A may indicate the power rails needed for the first chiplet 402A to boot. Similarly, the (“second”) boot rail information of the fuse array 404B may indicate the power rails needed for the second chiplet 402B to boot. The chiplets 402A and 402B may also include serial data communication (e.g., SPMI) interface circuitry 406A and 406B, respectively. Although not shown in FIG. 4 for purposes of clarity, each chiplet 402A and 402B may include circuitry (e.g., control logic, registers, etc.) configured, for example, in the manner described above with regard to the system 200 (FIG. 2), to read the boot rail information from the respective fuse arrays 404A and 404B and provide the boot rail information via the respective serial data communication interface circuitry 406A and 406B.

The system 400 may include a PMIC 408, which may include serial data communication interface circuitry 410. The serial data communication interface circuitry 410 of the PMIC 408 may be coupled via a serial data communication bus 412 to the serial data communication interface circuitry 406A of the first chiplet 402A and the serial data communication interface circuitry 406B of the second chiplet 402B. The serial data communication interface circuitry 406A and 406B in the chiplets 402A and 402B may be, for example, SPMI slaves, while the serial data communication interface circuitry 410 in the PMIC 408 may be a SPMI master. Each SPMI slave may be configured to arbitrate the serial data communication bus 412 and send an interrupt (e.g., the SPMI Request Capable Slave (RCS) interrupt) to the SPMI master once the data at the slave is ready. The serial data communication interface circuitry 410 (e.g., SPMI master) in the PMIC 408 may read the fuse values, i.e., boot rail information, from the serial data communication interface circuitry 406A or 406B (e.g., SPMI slave) either as a response to the RCS interrupt or, alternatively, by polling.

When the PMIC 408 has received the first boot rail information from the first chiplet 402A and the second boot rail information from the second chiplet 402B, the PMIC 408 may power up the power rails indicated by the first and second boot rail information. When the PMIC 408 has powered up all power rails indicated by the first and second boot rail information, the PMIC 408 may send the Pwr_Rdy signal described above with regard to FIG. 2 to each chiplet 402A and 402B. Each chiplet 402A and 402B may boot when it receives the Pwr_Rdy signal. Other aspects of operation of the system 400 may be similar to the aspects described above with regard to the system 200 (FIG. 2).

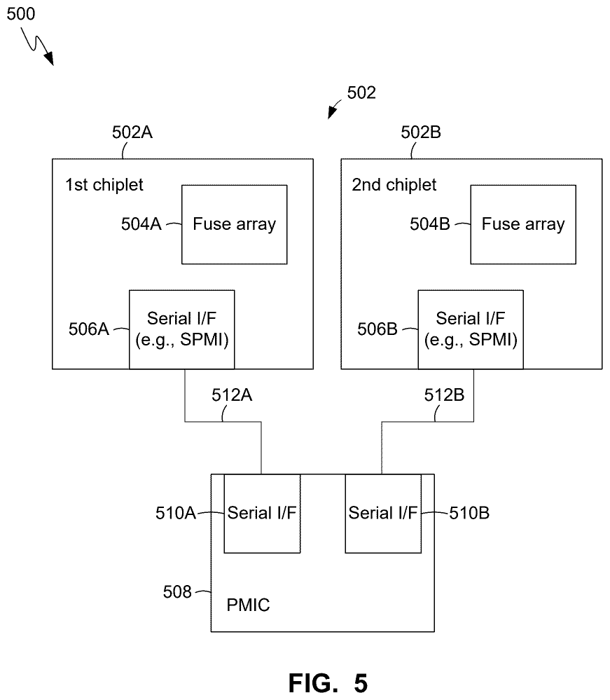

In FIG. 5, a system 500 may include two or more chiplets 502, such as a first chiplet 502A and a second chiplet 502B. The chiplets 502A and 502B may be similar to the above-described chiplets 402A and 402B (FIG. 4). Accordingly, the chiplet 502A may include a fuse array 504A and serial data communication interface circuitry 506A, while the chiplet 502B may include a fuse array 504B and serial data communication interface circuitry 506B. The fuse array 504A may be configured with first boot rail information associated with the first chiplet 502A, and the fuse array 504B may be configured with second boot rail information associated with the second chiplet 502B. Although not shown in FIG. 5 for purposes of clarity, each chiplet 502A and 502B may include circuitry (e.g., control logic, registers, etc.) configured, for example, in the manner described above with regard to the system 200 (FIG. 2), to read the boot rail information from the respective fuse arrays 504A and 504B and provide the boot rail information via the respective serial data communication interface circuitry 506A and 506B.

The system 500 may include a PMIC 508, which may include first serial data communication interface circuitry 510A and second serial data communication interface circuitry 510B. The first serial data communication interface circuitry 510A of the PMIC 508 may be coupled via a first serial data communication bus 512A to the serial data communication interface circuitry 506A of the first chiplet 502A. The second serial data communication interface circuitry 510B of the PMIC 508 may be coupled via a second serial data communication bus 512B to the serial data communication interface circuitry 506B of the second chiplet 502B.

The first serial data communication interface circuitry 510A (e.g., SPMI master) in the PMIC 508 may read the fuse values, i.e., the first boot rail information, from the serial data communication interface circuitry 506A (e.g., SPMI slave). The second serial data communication interface circuitry 510B (e.g., SPMI master) in the PMIC 508 may read the fuse values, i.e., the second boot rail information, from the serial data communication interface circuitry 506B (e.g., SPMI slave). When the PMIC 508 has received the first boot rail information from the first chiplet 502A and the second boot rail information from the second chiplet 502B, the PMIC 508 may power up the power rails indicated by the first and second boot rail information. When the PMIC 508 has powered up all power rails indicated by the first and second boot rail information, the PMIC 508 may send the Pwr_Rdy signal described above with regard to FIG. 2 to each chiplet 502A and 502B via the first and second serial data communication buses 512A and 512B, respectively. That is, the PMIC 508 may send a first Pwr_Rdy signal to the first chiplet 502A via the first serial data communication bus 512A and send a second Pwr_Rdy signal to the second chiplet 502B via the second serial data communication bus 512B. Each chiplet 502A and 502B may boot when it receives its respective Pwr_Rdy signal. Other aspects of operation of the system 500 may be similar to the aspects described above with regard to the system 200 (FIG. 2).

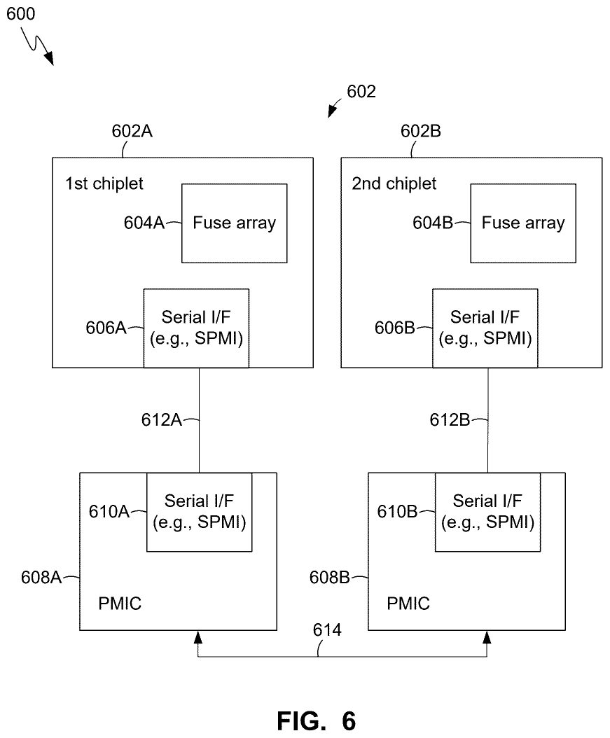

In FIG. 6, a system 600 may include two or more chiplets 602, such as a first chiplet 602A and a second chiplet 602B. The chiplets 602A and 602B may be similar to the above-described chiplets 402A and 402B (FIG. 4), and 502A and 502B (FIG. 5). Accordingly, the chiplet 602A may include a fuse array 604A and serial data communication interface circuitry 606A, while the chiplet 602B may include a fuse array 604B and serial data communication interface circuitry 606B. The fuse array 604A may be configured with first boot rail information associated with the first chiplet 602A, and the fuse array 604B may be configured with second boot rail information associated with the second chiplet 602B. Although not shown in FIG. 6 for purposes of clarity, each chiplet 602A and 602B may include circuitry (e.g., control logic, registers, etc.) configured, for example, in the manner described above with regard to the system 200 (FIG. 2), to read the boot rail information from the respective fuse arrays 604A and 604B and provide the boot rail information via the respective serial data communication interface circuitry 606A and 606B.

The system 600 may include a first PMIC 608A, which may include serial data communication interface circuitry 610A, and a second PMIC 608B, which may include serial data communication interface circuitry 610B. The serial data communication interface circuitry 610A of the first PMIC 608A may be coupled via a first serial data communication bus 612A to the serial data communication interface circuitry 606A of the first chiplet 602A. The serial data communication interface circuitry 610B of the second PMIC 608B may be coupled via a second serial data communication bus 612B to the serial data communication interface circuitry 606B of the second chiplet 602B.

The serial data communication interface circuitry 610A (e.g., SPMI master) in the first PMIC 608A may read the fuse values, i.e., the first boot rail information, from the serial data communication interface circuitry 606A (e.g., SPMI slave) of the first chiplet 602A. The serial data communication interface circuitry 610B (e.g., SPMI master) in the second PMIC 608B may read the fuse values, i.e., the second boot rail information, from the serial data communication interface circuitry 606B (e.g., SPMI slave) of the second chiplet 602B. When the second PMIC 608B has received the second boot rail information from the second chiplet 602B, the second PMIC 608B may power up the power rails indicated by the second boot rail information and then send an acknowledgement signal 614 to the first PMIC 608A. When the first PMIC 608A has received the first boot rail information from the first chiplet 602A and received the acknowledgement signal 614 from the second PMIC 608B, the first PMIC 608A may power up the power rails indicated by the first boot rail information.

When the first PMIC 608A has powered up the power rails indicated by the first boot rail information, the first PMIC 608A may send a first Pwr_Rdy signal to the first chiplet 502A via the first serial data communication bus 612A. The first chiplet 602A may boot when it receives the first Pwr_Rdy signal. When the second PMIC 608A has powered up the power rails indicated by the second boot rail information, the second PMIC 608B may send a second Pwr_Rdy signal to the second chiplet 602B via the second serial data communication bus 612B. The second chiplet 602B may boot when it receives the second Pwr_Rdy signal. Other aspects of operation of the system 600 may be similar to the aspects described above with regard to the system 200 (FIG. 2).

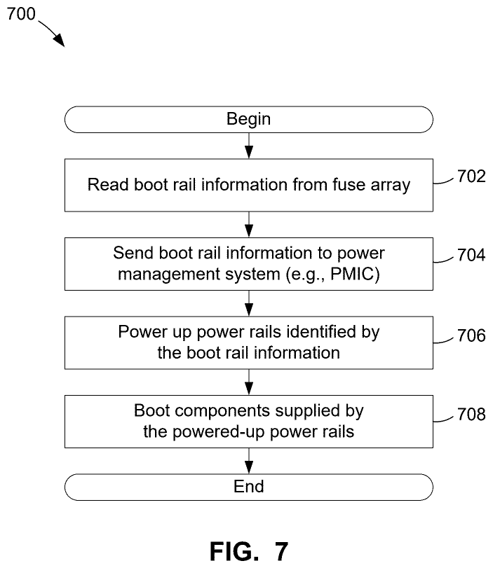

In FIG. 7, a method 700 for dynamic power rail selection in a SoC is illustrated in flow diagram form. As indicated by block 702, the method 700 may include reading boot rail information from a fuse array. The reading may be performed or controlled by, for example, control circuitry in an SoC having the fuse array. As indicated by block 704, the method 700 may also include sending the boot rail information to a power management system (e.g., in a PMIC). The boot rail information may indicate one or more power rails of a plurality of power rails. The sending may be performed or controlled by the control circuitry or the control circuitry together with data communication interface circuitry.

As indicated by block 706, the method 700 may further include powering up, the one or more power rails indicated by the boot rail information. The powering up may be performed or controlled by the power management system in response to receiving the boot rail information. As indicated by block 708, the method 700 may still further include booting one or more processing components supplied by the one or more power rails indicated by the boot rail information. Booting may be performed or controlled by a boot controller in response to the power-up of the one or more power rails. For example, booting may be performed in response to an acknowledgement or power-ready indication, indicating that the one or more power rails have been powered up.

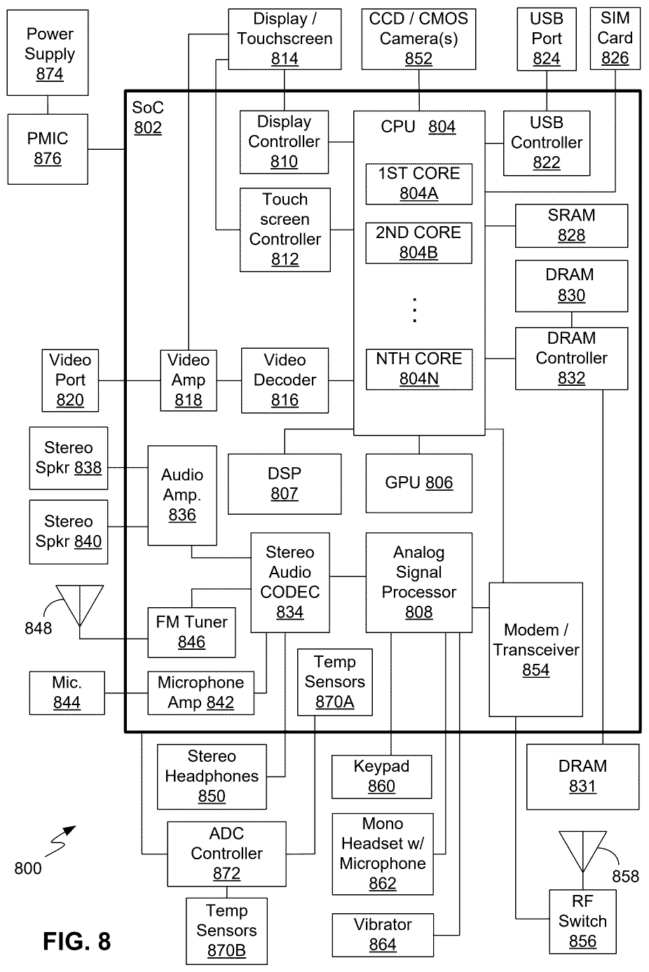

FIG. 8 illustrates an example of a portable computing device (PCD) 800, in which exemplary embodiments of systems, methods, and other examples of the above-described dynamic power rail selection may be provided. The PCD 800 may be, for example, a laptop or palmtop computer, cellular telephone or smartphone, personal digital assistant, navigation device, smartbook, portable game console, satellite telephone, automotive device, Internet-of-Things (IoT) device, etc.

The PCD 800 may include an SoC 802. The SoC 802 may be an example of above-described SoC 102 (FIGS. 1), 202 (FIG. 2), etc. The SoC 802 may include a CPU 804, a GPU 806, a digital signal processor (DSP) 807, an analog signal processor 808, a modem/modem subsystem 854, or other processors. The CPU 804 may include one or more CPU cores, such as a first CPU core 804A, a second CPU core 804B, etc., through an Nth CPU core 804N. Any of the foregoing processors or subsystems may be examples of the above-described processing subsystems 108 (FIG. 1) or 206 (FIG. 2). For example, the CPU 804 may be an example of the CPU subsystem 206A (FIG. 2).

A display controller 810 and a touch-screen controller 812 may be coupled to the CPU 804. A touchscreen display 814 external to the SoC 802 may be coupled to the display controller 810 and the touch-screen controller 812. The PCD 800 may further include a video decoder 816 coupled to the CPU 804. A video amplifier 818 may be coupled to the video decoder 816 and the touchscreen display 814. A video port 820 may be coupled to the video amplifier 818. A universal serial bus (USB) controller 822 may also be coupled to CPU 804, and a USB port 824 may be coupled to the USB controller 822. A subscriber identity module (SIM) card 826 may also be coupled to the CPU 804.

The CPU 804 may be coupled to one or more memories, with which the CPU 804 or other processors may initiate memory transactions. The one or more memories may include both volatile and non-volatile memories. Examples of volatile memories may include static random access memory (SRAM) 828 and dynamic random access memory (DRAM) 830 and 831. Such memories may be internal to the SoC 802, as in the case of the SRAM 828 and DRAM 830, or external to the SoC 802, as in the case of the DRAM 831. A DRAM controller 832 coupled to the CPU 804 may control the writing of data to, and reading of data from, the DRAMs 830 and 831.

A stereo audio CODEC 834 may be coupled to the analog signal processor 808. Further, an audio amplifier 836 may be coupled to the stereo audio CODEC 834. First and second stereo speakers 838 and 840, respectively, may be coupled to the audio amplifier 836. In addition, a microphone amplifier 842 may be coupled to the stereo audio CODEC 834, and a microphone 844 may be coupled to the microphone amplifier 842. A frequency modulation (FM) radio tuner 846 may be coupled to the stereo audio CODEC 834. An FM antenna 848 may be coupled to the FM radio tuner 846. Further, stereo headphones 850 may be coupled to the stereo audio CODEC 834. Other devices that may be coupled to the CPU 804 include one or more digital (e.g., CCD or CMOS) cameras 852.

The RF transceiver or modem subsystem 854 may be coupled to the analog signal processor 808 and the CPU 804. An RF switch 856 may be coupled to the modem subsystem 854 and an RF antenna 858. In addition, a keypad 860, a mono headset with a microphone 862, and a vibrator device 864 may be coupled to the analog signal processor 808.

The SoC 802 may have one or more internal or on-chip thermal sensors 870A and may be coupled to one or more external or off-chip thermal sensors 870B. An analog-to-digital converter controller 872 may convert voltage drops produced by the thermal sensors 870A and 870B to digital signals. A power supply 874 and a power management integrated circuit (PMIC) 876 may supply power to the SoC 802. The PMIC 876 may be an example of the above-described PMIC 104 (FIG. 1) or 204 (FIG. 2).

Implementation examples are described in the following numbered clauses.
1. A method for dynamic power rail selection, comprising:
sending, by control circuitry, boot rail information to a power management system, the boot rail information indicating one or more power rails of a plurality of power rails;
powering up, by the power management system in response to receiving the boot rail information, the one or more power rails indicated by the boot rail information; and
booting, by a boot controller in response to power-up of the one or more power rails, one or more processing components supplied by the one or more power rails.
2. The method of claim 1, further comprising sending, by the power management system, an acknowledgement to the control circuitry after powering up the one or more power rails.
3. The method of claim 2, wherein booting the one or more processing components comprises booting the one or more processing components in response to the acknowledgement.
4. The method of any of claims 1-3, further comprising reading, by the control circuitry, the boot rail information from a fuse array.
5. The method of any of claims 1-4, wherein sending the boot rail information comprises sending the boot rail information via at least one serial data communication bus.
6. The method of claim 5, wherein the power management system is included in at least one Power Management Integrated Circuit (PMIC), and the serial data communication bus comprises at least one Serial Power Management Interface (SPMI) bus.
7. The method of any of claims 1-6, wherein the control circuitry, the boot controller, and the one or more processing components are included in a system-on-chip (SoC) or each of a plurality of chiplets, and further comprising sending, by the power management system, an acknowledgement to the SoC or each of the plurality of chiplets after powering up the one or more power rails, and wherein booting the one or more processing components comprises booting the one or more processing components in response to the acknowledgement.
8. A system for dynamic power rail selection, comprising:
boot rail information control circuitry configured to send boot rail information to a power management system, the boot rail information indicating one or more power rails of a plurality of power rails, wherein the power management system is configured to power up the one or more power rails indicated by the boot rail information; and
boot control circuitry configured to boot, in response to power-up of the one or more power rails, one or more processing components supplied by the one or more power rails.
9. The system of claim 8, wherein the power management system is configured to send an acknowledgement to the boot rail information control circuitry after powering up the one or more power rails.
10. The system of claim 9, wherein the boot control circuitry is configured to boot the one or more processing components in response to the acknowledgement.
11. The system of any of claims 8-10, wherein the boot rail information control circuitry is configured to read the boot rail information from a fuse array.
12. The system of any of claims 8-11, wherein the boot rail information control circuitry is configured to send the boot rail information via at least one serial data communication bus.
13. The system of claim 12, wherein the power management system is included in at least one Power Management Integrated Circuit (PMIC), and the serial data communication bus comprises at least one Serial Power Management Interface (SPMI) bus.
14. The system of any of claims 8-13, wherein the control circuitry, the boot control circuitry, and the one or more processing components are included in a system-on-chip (SoC) or each of a plurality of chiplets, and wherein the power management system is configured to send an acknowledgement to the SoC or each of the plurality of chiplets after powering up the one or more power rails, and wherein the boot control circuitry is configured to boot the one or more processing components in response to the acknowledgement.
15. A processing system, comprising:
a plurality of processing components in a system-on-chip (SoC) or a plurality of chiplets;
boot rail information control circuitry in the SoC or each of the plurality of chiplets configured to send boot rail information to a power management integrated circuit (PMIC) via a data communication bus, the boot rail information indicating one or more power rails of a plurality of power rails, wherein the PMIC is configured to power up the one or more power rails indicated by the boot rail information; and
boot control circuitry associated with the plurality of processing components configured to boot, in response to power-up of the one or more power rails, one or more processing components supplied by the one or more power rails.
16. The processing system of claim 15, wherein the PMIC is configured to send an acknowledgement to the SoC or each of the plurality of chiplets after powering up the one or more power rails.
17. The processing system of claim 16, wherein the boot control circuitry is configured to boot the one or more processing components in response to the acknowledgement.
18. The processing system of any of claims 15-17, wherein the boot rail information control circuitry is configured to read the boot rail information from a fuse array in the SoC or each of the plurality of chiplets.
19. The processing system of any of claims 15-18, further comprising register circuitry in the SoC or the plurality of chiplets, wherein the boot rail information control circuitry is configured to read the boot rail information from the fuse array into the register circuitry and send the boot rail information from the register circuitry to the PMIC.
20. The processing system of any of claims 15-19, wherein the boot rail information control circuitry in the SoC or each of the plurality of chiplets is configured to send the boot rail information to the PMIC in response to a system power-on reset trigger.

Alternative embodiments will become apparent to one of ordinary skill in the art to which the invention pertains. Therefore, although selected aspects have been illustrated and described in detail, it will be understood that various substitutions and alterations may be made therein.

What is claimed is:

1. A method for dynamic power rail selection, comprising:
sending, by control circuitry, boot rail information to a power management system, the boot rail information indicating one or more power rails of a plurality of power rails;
powering up, by the power management system in response to receiving the boot rail information, the one or more power rails indicated by the boot rail information; and
booting, by a boot controller in response to power-up of the one or more power rails, one or more processing components supplied by the one or more power rails.

2. The method of claim 1, further comprising sending, by the power management system, an acknowledgement to the control circuitry after powering up the one or more power rails.

3. The method of claim 2, wherein booting the one or more processing components comprises booting the one or more processing components in response to the acknowledgement.

4. The method of claim 1, further comprising reading, by the control circuitry, the boot rail information from a fuse array.

5. The method of claim 1, wherein sending the boot rail information comprises sending the boot rail information via at least one serial data communication bus.

6. The method of claim 5, wherein the power management system is included in at least one Power Management Integrated Circuit (PMIC), and the serial data communication bus comprises at least one Serial Power Management Interface (SPMI) bus.

7. The method of claim 5, wherein the control circuitry, the boot controller, and the one or more processing components are included in a system-on-chip (SoC) or each of a plurality of chiplets, and further comprising sending, by the power management system, an acknowledgement to the SoC or each of the plurality of chiplets after powering up the one or more power rails, and wherein booting the one or more processing components comprises booting the one or more processing components in response to the acknowledgement.

8. A system for dynamic power rail selection, comprising:
boot rail information control circuitry configured to send boot rail information to a power management system, the boot rail information indicating one or more power rails of a plurality of power rails, wherein the power management system is configured to power up the one or more power rails indicated by the boot rail information; and
boot control circuitry configured to boot, in response to power-up of the one or more power rails, one or more processing components supplied by the one or more power rails.

9. The system of claim 8, wherein the power management system is configured to send an acknowledgement to the boot rail information control circuitry after powering up the one or more power rails.

10. The system of claim 9, wherein the boot control circuitry is configured to boot the one or more processing components in response to the acknowledgement.

11. The system of claim 8, wherein the boot rail information control circuitry is configured to read the boot rail information from a fuse array.

12. The system of claim 8, wherein the boot rail information control circuitry is configured to send the boot rail information via at least one serial data communication bus.

13. The system of claim 12, wherein the power management system is included in at least one Power Management Integrated Circuit (PMIC), and the serial data communication bus comprises at least one Serial Power Management Interface (SPMI) bus.

14. The system of claim 13, wherein the control circuitry, the boot control circuitry, and the one or more processing components are included in a system-on-chip (SoC) or each of a plurality of chiplets, and wherein the power management system is configured to send an acknowledgement to the SoC or each of the plurality of chiplets after powering up the one or more power rails, and wherein the boot control circuitry is configured to boot the one or more processing components in response to the acknowledgement.

15. A processing system, comprising:
a plurality of processing components in a system-on-chip (SoC) or a plurality of chiplets;
boot rail information control circuitry in the SoC or each of the plurality of chiplets configured to send boot rail information to a power management integrated circuit (PMIC) via a data communication bus, the boot rail information indicating one or more power rails of a plurality of power rails, wherein the PMIC is configured to power up the one or more power rails indicated by the boot rail information; and
boot control circuitry associated with the plurality of processing components configured to boot, in response to power-up of the one or more power rails, one or more processing components supplied by the one or more power rails.

16. The processing system of claim 15, wherein the PMIC is configured to send an acknowledgement to the SoC or each of the plurality of chiplets after powering up the one or more power rails.

17. The processing system of claim 16, wherein the boot control circuitry is configured to boot the one or more processing components in response to the acknowledgement.

18. The processing system of claim 15, wherein the boot rail information control circuitry is configured to read the boot rail information from a fuse array in the SoC or each of the plurality of chiplets.

19. The processing system of claim 18, further comprising register circuitry in the SoC or the plurality of chiplets, wherein the boot rail information control circuitry is configured to read the boot rail information from the fuse array into the register circuitry and send the boot rail information from the register circuitry to the PMIC.

20. The processing system of claim 15, wherein the boot rail information control circuitry in the SoC or each of the plurality of chiplets is configured to send the boot rail information to the PMIC in response to a system power-on reset trigger.
